(19) United States
(12) Patent Application Publication
(10) Pub. No.: US 2007/0284389 A1
(43) Pub. Date: Dec. 13, 2007

(54) Storage And Dispensing Of Wine From A Bladder Located Within A Barrel

(76) Inventor: Keith Reginald Jacobs, Ferny Creek (AU)

Correspondence Address: MICHAEL BEST & FRIEDRICH LLP, 100 E WISCONSIN AVENUE, Suite 3300, MILWAUKEE, WI, 53202, US

(21) Appl. No.: 11/572,468

(22) PCT Filed: Jul. 19, 2005
(86) PCT No.: PCT/AU05/01059

§ 371 Date: Jun. 26, 2007

(30) Foreign Application Priority Data
Jul. 22, 2004 (AU) 2004904065

(51) Int. Cl. B65D 77/06; G01F 11/00; B65D 35/56

(52) U.S. Cl. 222/1; 141/314; 206/524.8; 222/105

(57) ABSTRACT

Abstract: A method of storing and dispensing wine comprising locating a flexible bladder (50) within a walled container such as a oak barrel (20) with the bladder in fluid communication with an aperture (28) positioned adjacent one edge of a wall of the container; orientating the container so that the aperture (28) is at the top of the container; filling the flexible bladder with wine via the aperture (28); sealing the aperture (28) with a tap (71); expelling the air from within the bladder via the tap using a vacuum pump (77); inverting the container so that the tap is at the bottom of the container; and drawing off the wine from the tap. The barrel (20) is supported on means such as a trestle (11) which has roller bearings (15) to facilitate free axial rotation of the barrel.

This invention relates to a method of storing and dispensing wine and a storage and dispensing system.

### BACKGROUND OF THE INVENTION

The correct storage and means of dispensing wine has been a problem the world over.

When wine is exposed to air it oxidises with the oxygen in air reacting with the sulfur that is present in the wine to produce sulphates and sulphurdioxide that substantially reduce and impairs the quality and taste of the wine. Thus, in the manufacture and storage of wine there is a continual need to prevent oxidisation. This is a particular problem with bottles or large containers of wine that are not consumed immediately and are often left standing at a partially empty state where the wine can react with the air that is in the container. The storage of wine in bulk is a problem and often results in considerably wastage frequently caused by oxidisation.

One popular solution to this problem is the wine cask in which a flexible bag or bladder is used to house the wine and as the wine is consumed the bag or bladder collapses effectively ensuring that there is no air within the bag or bladder to cause oxidisation.

It is these issues that have brought about the present invention.

### SUMMARY OF THE INVENTION

According to one aspect of the present invention there is provided a method of storing and dispensing wine comprising locating a flexible bladder within a walled container with the bladder in fluid communication with an aperture positioned adjacent one edge of a wall of the container; orientating the container so that the aperture is at the top of the container; filling the flexible bladder with wine via the aperture; sealing the aperture with a tap; expelling the air from within the bladder via the tap; inverting the container so that the tap is at the bottom of the container; and drawing off the wine from the tap.

Preferably, the flexible bladder is positioned in a container of circular cross section that can be rotated to place the aperture at the top and bottom positions.

Preferably, a vacuum pump is used to expel the air from the flexible bladder.

In accordance with a further aspect of the present invention there is provided a wine storage and dispensing system comprising a walled container with an aperture adjacent one edge of a wall of the container, a fluid coupling located within the aperture with an inner end arranged to be attached to a flexible bladder located in the container and an outer end arranged to be coupled to a tap to close off the aperture when closed and allow the wine to be drawn off when open, and means to support the container in either an upright position with the aperture at the top of the container to facilitate filling of the container or an inverted position with the aperture at the bottom of the container to facilitate drawing off of the wine.

Preferably, the container is of circular cross section so that it is rotated from the upright to the inverted position.

In a preferred embodiment the container is a wooden wine barrel with a removable front face to which the flexible bladder is attached with the inlet/outlet aperture being positioned adjacent the edge of the face and supporting a fluid coupling.

In the preferred embodiment the fluid coupling is adapted to receive a variety of couplings to effect filling, evacuation of the air and dispensing of the wine.

### DESCRIPTION OF THE DRAWINGS

Embodiments of the present invention will now be described by way of example only with reference to the accompanying drawings in which:

FIG. 1 is a end elevation of a wine barrel supported on a trestle in accordance with one embodiment of the present invention,

FIG. 2 is a side elevational view of the barrel and trestle,

FIG. 3 is a detailed view of the area within the circle A on FIG. 2,

FIG. 4 is a end elevational view of the barrel inverted for filling,

FIG. 5 is a end elevational view of the barrel when ready to dispense wine,

FIG. 6 is an exploded cross sectional view that illustrates the connection of a bladder to the front face of the barrel,

FIG. 7 is a side elevational view of a tap assembly for connection to a vacuum pump,

FIG. 8 is a plan view of a filling adapter coupled to a feed pipe, and

FIG. 9 is a cross sectional view of the rear of the barrel illustrating the support of the barrel.

### DESCRIPTION OF THE PREFERRED EMBODIMENTS

The device 10 for storing and dispensing wine as illustrated in the accompanying drawings comprises a barrel 20 containing a bladder 50 and supported on a trestle 11. The oak wine barrel 20 of traditional style is adapted to be supported upon an adjustable trestle 11 so that the height of the barrel can vary from 300 mm to 1000 mm. In the preferred embodiment the illustrated wine barrel 20 has a capacity of 225 L.

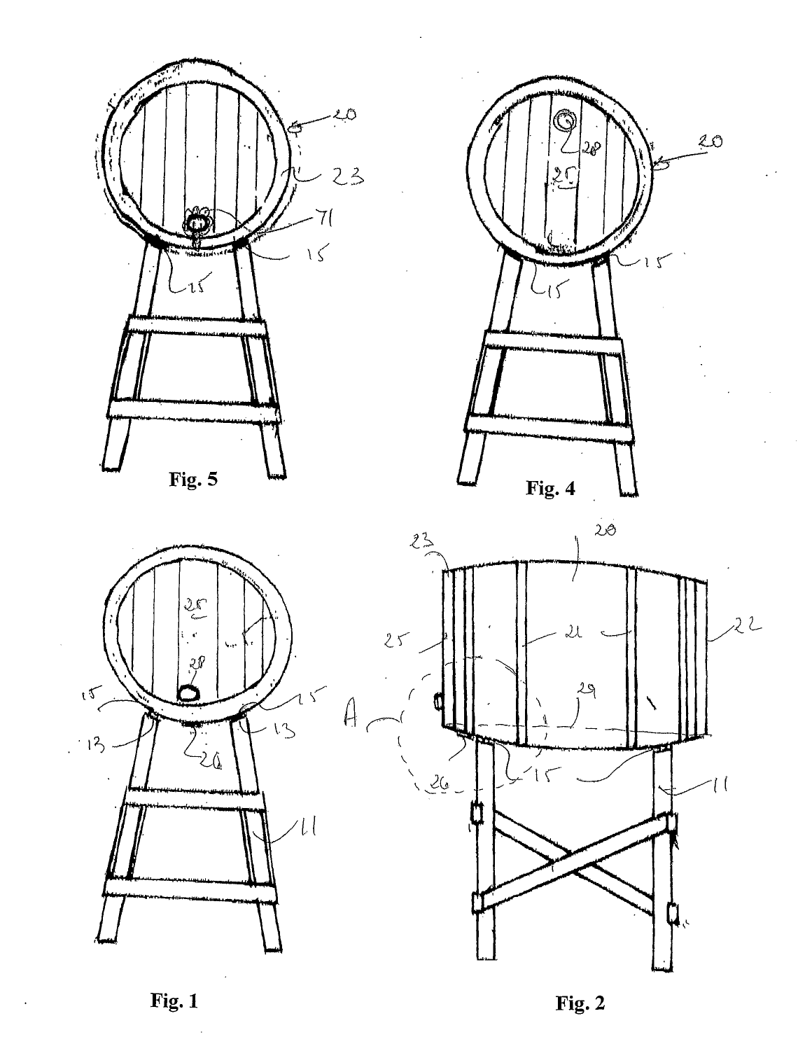

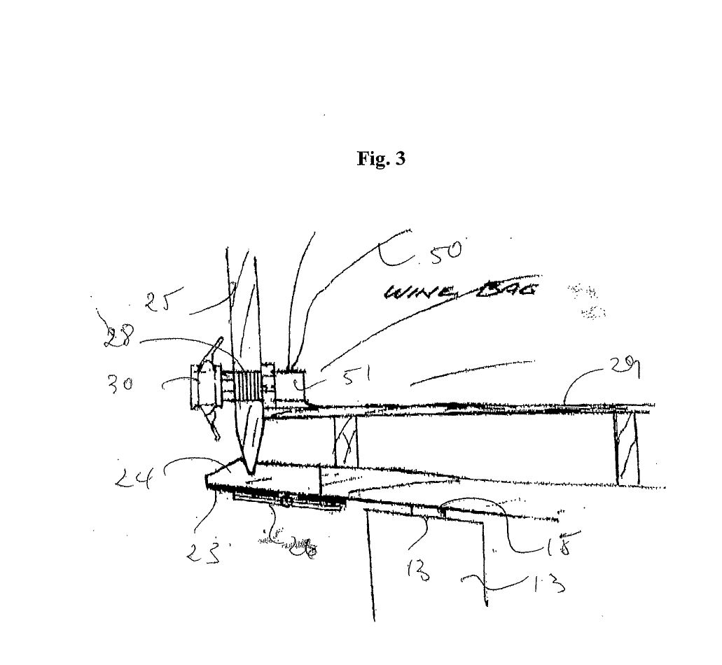

As shown in FIGS. 1 to 5, the wine barrel 20 has a conventional casing of circular cross section reinforced by spaced steel hoops 21. The barrel is closed at one end 22 but the forward end including a chime hoop 23, a wooden rim 24 and end face 25 is designed to be hinged from the remainder of the barrel to provide access to the interior. As shown in FIG. 3, a suitable hinge 26 and latching mechanism (not shown) is provided which may be concealed so that the removability of the front face 25 is not obvious. Alternatively the front face of the barrel is designed to slide off the main body of the barrel. The barrel 20 has a horizontal internal floor 29 shown in FIG. 3.

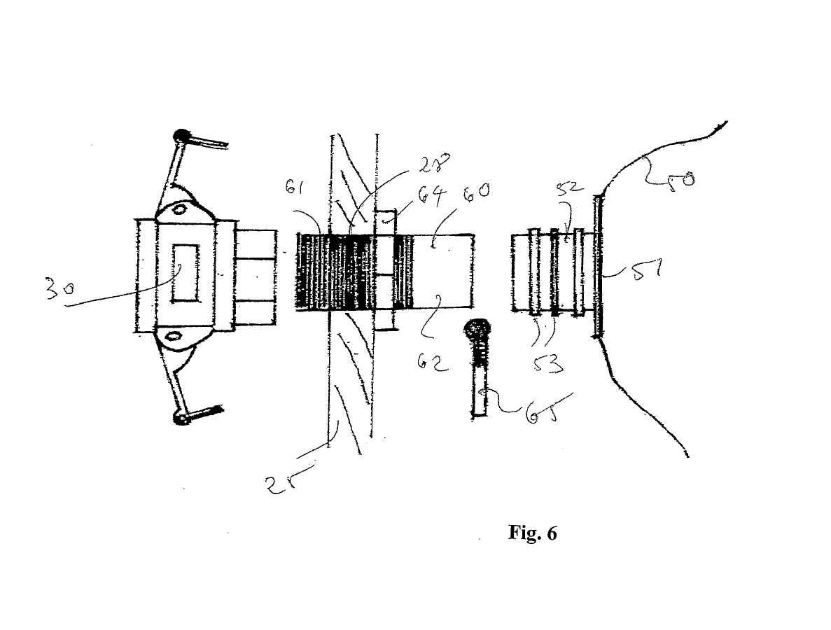

The front face 25 of the barrel has an aperture 28 positioned adjacent the periphery and this aperture supports a cylindrical sleeve 60 and female metal coupling known as a cam lock 30. As shown in FIG. 6 the stainless steel cylindrical sleeve 60 is externally threaded at one end 61 to terminate in an unthreaded shank 62 at the other extends amongst the aperture 28 and is held against the inner wall of the front face 25 of the barrel by a lock nut 64. The unthreaded end 60 of the sleeve is arranged to be a sliding fit within the projecting fitting 52 of the bladder 50. A worm drive clamp 65 or other clamping mechanism is then positioned around the fitting 52 of the bladder to clamp the projection onto the end of the sleeve 60. The cam lock 30 has an internally threaded end that is arranged to be a screw fit on the end 61 of the sleeve 60 to firmly clamp the cam lock against the front face of the barrel against the lock nut 64. In this manner the bladder 50 is firmly and positively secured to the aperture 28 in the front face 25 of the barrel 20. The bladder is positioned on the interior of the barrel on the internal floor 29 and is designed to accommodate 200 L of wine. The cam lock 30 coupling can be a snap fit coupling that allows axial rotation of the components thereby allowing the cam lock to rotate relative to the bladder to ensure that the bladder is not twisted on filling.

The interior of the barrel supports the flexible bladder 50 that is made of metal foil, plastics or rubber, the bladder 50 has a single opening 51 sealed to a plastics fitting 52 with a ribbed exterior 53. The bladder 50 with the projecting plastics fitting 52 is a commercially available product and is thus not described in further detail.

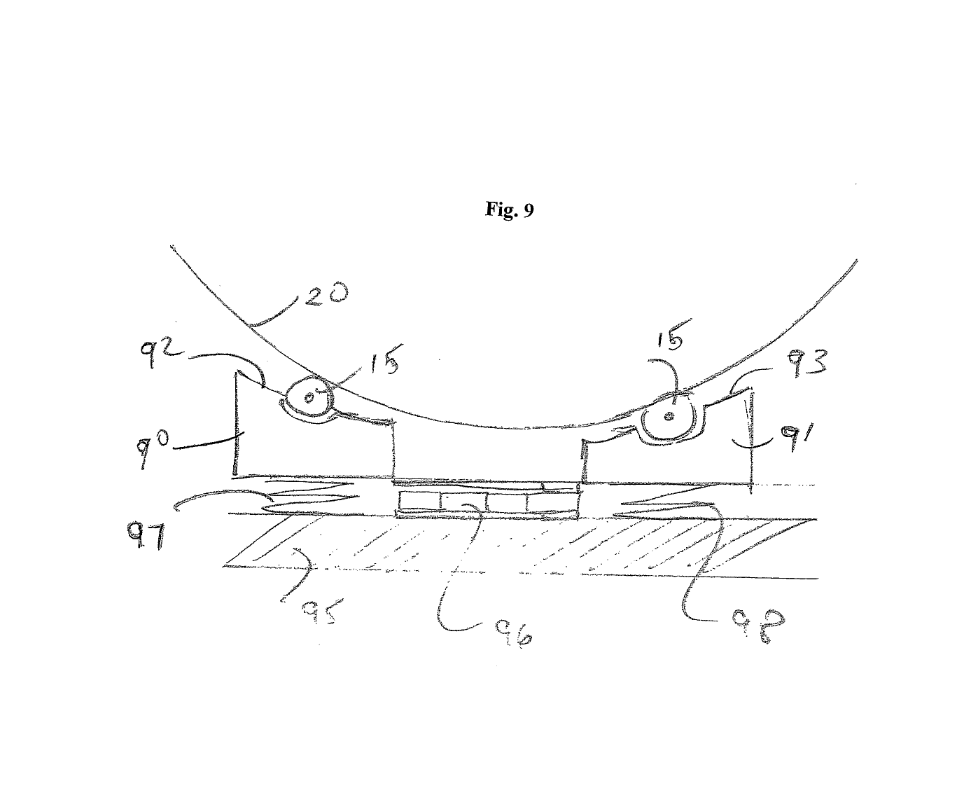

The supporting trestle 11 for the wine barrel has a pair of spaced arcuate bearing surfaces 12 and 13, each of which supports spaced roller bearings 15 that take the load of the barrel. The roller bearings 15 allow the barrel 20 to rotate about its longitudinal axis on the trestle whilst still taking the load of the barrel. With a large and comparatively heavy barrel 20 there is a need for bearing support to facilitate rotatability. However it is understood that with a smaller and lighter barrel it will be possible to simply lift the barrel and effect the rotation. As shown in FIG. 2 the barrel 20 is supported at two axially spaced locations. FIG. 9 shows the rear support for the barrel 20. A pair of blocks 90, 91 with arcuate bearing surfaces 92, 93 are hinged to on base block 95 via a hinge 96. Springs 97, 98 are located beneath each block 90, 91 to urge the block upwardly. The blocks 90, 91 engage the underside of the barrel 20 via bearings 15. When the barrel is full the weight of the wine causes the blocks 90, 91 to compress the springs 97, 98. As the barrel empties the springs urge the blocks 90, 91 upwards to cause the barrel to tilt forward thereby ensuring that all the contents escape the front aperture 28.

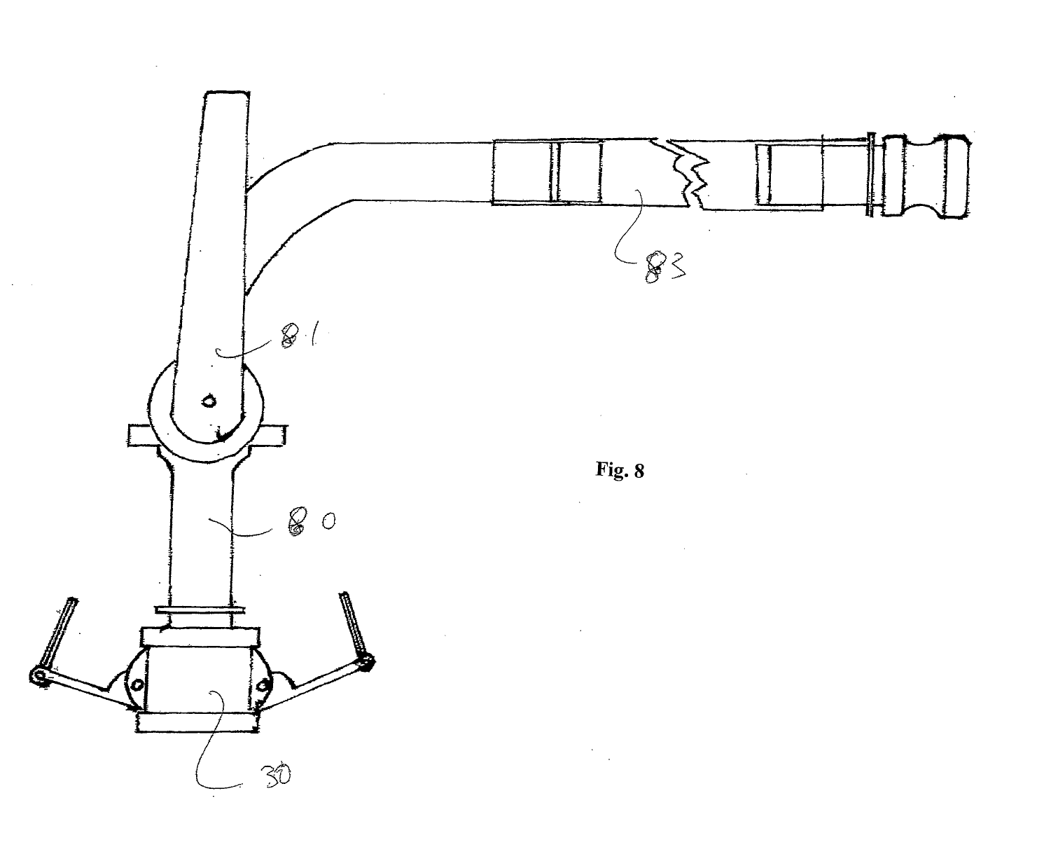

To fill the barrel with wine the front face 25 of the barrel 20 is removed and attached to the bag bladder 50 which is positioned within the interior of the barrel 20. The front face 25 is repositioned on the end of the barrel 20 and the barrel 20 is turned so that the female coupling 30 is in the highest position shown in FIG. 4. As shown in FIG. 8, a male coupling 80 of a feed line from a source of wine with a shut-off valve 81 and handle 82 is then sealingly inserted against the female socket 30 of the cam lock and wine is pumped or gravity fed from the external source via a clear hose 83 directly into the barrel 20 until the bladder 50 contains the correct quantity of 200 L of wine.

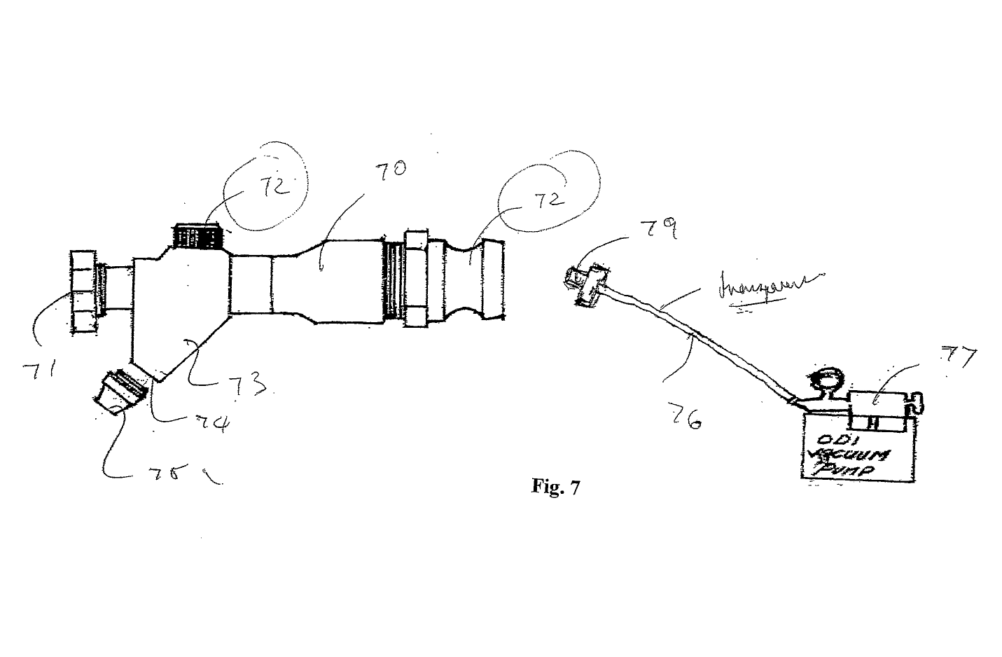

The male coupling and shut off valve 80, 81 is then removed from the female cam lock 30 and replaced by a tap assembly 70 shown in FIG. 7 that has a male projection 72 that is snap fitted into the female cam lock 30. The assembly 70 has a main body containing a tap valve (not shown) controlled by a tap handle 71. An outlet aperture 74 is positioned at the end of a downwardly projecting outlet 73. An adaptor 75 is threadedly located in the outlet aperture 74. The adaptor 75 can be replaced by an end coupling 79 which is positioned on the end of a narrow tube 76 which is coupled to a vacuum pump 77. Thus, once the bladder 50 is full of wine the vacuum pump 77 can be operated to remove via the tube 76 whatever air there is between the top of the wine and the interior of the bladder. The tube 76 is of transparent plastics so that it provides a visual indication of passage of wine confirming that all the air has been removed. When the air has been removed the tap is turned off.

It is understood that it is possible to couple the same line 76 to a source of CO₂ and a small amount of CO₂ can be injected into the bladder if it is deemed necessary by turning the tap on, injecting the CO₂ and then turning the tap off. The barrel is then turned through 180° so that the cam lock 30 and top assembly 70 are at the base of the barrel as shown in FIGS. 1, 2 and 5.

The tap 71 can then be turned on to allow the wine to escape from the barrel via the aperture 74 due to gravity. Since there is no air in the bladder as the wine is consumed the bladder collapses until the bladder becomes empty. Preferably, at this stage the front cover is removed, the bladder is removed from the coupling and a replacement bladder is positioned on the coupling. The operation is then repeated, the barrel is refilled, the air removed and CO₂ is inserted as desired. It is however possible to simply refill the bladder.

This system provides a very effective way of storing wine without the likelihood of oxidisation. The wine can be dispensed periodically without the danger of ingress off air and the whole assembly is located in an aesthetically pleasing barrel and is gravity fed to not require ancillary equipment such as pumps or pressurised dispensing lines. The storage and dispensing system described above can be supplied as a kit which would include the barrel, some bladders, a tap assembly and an adjustable trestle. The kit could also include a wheeled trolley which carries the electric pump and vacuum pump. The trolley can support a large container of wine so that the trolley can be wheeled to the barrel to facilitate refilling of the barrel using the pump and vacuum pump.

Although in the preferred embodiment the storage device is housed within a oak barrel it is understood that many other types of containers can be used. It is important however that the container has a single inlet/outlet aperture near one edge of the container and that the container can be inverted for filling purposes. It is further understood that the size and capacity of the container can vary from a very small quantity such as 10 L up to a large storage facility of say 1000 L.

1. A method of storing and dispensing wine comprising locating a flexible bladder within a walled container with the bladder in fluid communication with an aperture positioned adjacent one edge of a wall of the container; orientating the container so that the aperture is at the top of the container; filling the flexible bladder with wine via the aperture; sealing the aperture with a tap; expelling the air from within the bladder via the tap; inverting the container so that the tap is at the bottom of the container; and drawing off the wine from the tap.

2. The method according to claim 1 comprising locating a fluid coupling in the aperture with an inner end extending into the container and attached to the bladder and an outer end projecting out of the container.

3. The method according to claim 2 comprising filling the flexible bladder by attaching a feedline to the outer end of the coupling.

4. The method according to claim 2 comprising attaching the tap to the outer end of the coupling and coupling a vacuum pump to the tap to evacuate any air in the bladder.

5. A method according to claim 1 comprising using a container of circular cross section and rotating the container to place the aperture at the top and bottom positions.

6. The method according to claim 5 comprising positioning the container on a support with the wall of the container resting on bearings between the container and the support thereby facilitating free axial rotation of the container relative to the support.

7. The method according to claim 6 comprising raising the rear of the container as it empties to ensure all the contents of the bladder can be drawn off.

8. The method according to claim 1 comprising selecting a barrel with a removable front wall as the container and positioning the aperture adjacent the periphery of the front wall.

9. A wine storage and dispensing system comprising a walled container with an aperture adjacent one edge of a wall of the container, a fluid coupling located within the aperture with an inner end arranged to be attached to a flexible bladder located in the container and an outer end arranged to be coupled to a tap to close off the aperture when closed and allow the wine to be drawn off when open, and means to support the container in either an upright position with the aperture at the top of the container to facilitate filling of the container or an inverted position with the aperture at the bottom of the container to facilitate drawing off of the wine.

10. The wine storage and dispensing system according to claim 9 wherein the walled container is a barrel with a removable front wall, the front wall having the aperture positioned adjacent the periphery of the wall and the means to support the barrel facilitating axial rotation of the barrel.

11. The wine storage and dispensing system according to claim 10 wherein the means to support the barrel is a trestle on which the side of the barrel rests with bearings being positioned between the trestle and the barrel to facilitate free axial rotation of the barrel.

12. The wine storage and dispensing system according to claim 11 wherein the trestle supports the barrel in two axially spaced locations, the location adjacent the rear of the barrel including means to lift the barrel as it empties to cause the barrel to tilt forwardly to ensure all the contents of the barrel can be drawn off.

13. The wine storage and dispensing system according to claim 9 further including a vacuum pump that can be attached to the fluid coupling when the container is in the upright position to draw off any air that remains in the flexible bladder after it has been filled with wine.

14. The wine storage and dispensing system according to claim 9 wherein the tap includes an outlet aperture that can be coupled to a line from the vacuum pump.

15. The wine storage and dispensing system according to claim 9 wherein the front wall of the barrel is hinged to the barrel to provide access to the interior of the barrel.

16. The wine storage and dispensing system according to claim 9 wherein the size of the container and flexible bladder varies to accommodate capacities of between 10 and 1000 litres.

17. The method according to claim 3 comprising attaching the tap to the outer end of the coupling and coupling a vacuum pump to the tap to evacuate any air in the bladder.

18. The wine storage and dispensing system according to claim 12 further including a vacuum pump that can be attached to the fluid coupling when the container is in the upright position to draw off any air that remains in the flexible bladder after it has been filled with wine.

19. The wine storage and dispensing system according to claim 18 wherein the tap includes an outlet aperture that can be coupled to a line from the vacuum pump.

20. The wine storage and dispensing system according to claim 15 wherein the size of the container and flexible bladder varies to accommodate capacities of between 10 and 1000 litres.
